(19) United States
(12) Patent Application Publication
(10) Pub. No.: US 2026/0179408 A1
(43) Pub. Date: Jun. 25, 2026

(54) System and Method for Quantifying Layout Complexity in Multi-Lingual Digital Documents

(71) Applicant: Mohamed Sobhy M A Farag, Pittsburgh, PA (US)

(72) Inventor: Mohamed Sobhy M A Farag, Pittsburgh, PA (US)

(73) Assignee: Analytics 4 Everyone LLC, Pittsburgh, PA (US)

(21) Appl. No.: 19/183,956

(22) Filed: Apr. 21, 2025

(51) Int. Cl. G06V 30/413; G06F 40/205; G06V 10/40; G06V 10/764; G06V 10/77; G06V 30/18; G06V 30/244; G06V 30/246; G06V 30/414

(52) U.S. Cl. CPC G06V 30/413; G06F 40/205; G06V 10/40; G06V 10/764; G06V 10/7715; G06V 30/18; G06V 30/245; G06V 30/246; G06V 30/414

(57) ABSTRACT

A method and system are disclosed for computing a digital document layout complexity score by analyzing a comprehensive set of structural and linguistic features extracted from the document's content and visual layout. These features include, but are not limited to, page count, language type, presence of right-to-left scripts, tables, figures, formulas, handwriting indicators, and optical character recognition (OCR) confidence scores. Each feature is assigned a specific weight, and the method aggregates them into a unified complexity score through a weighted combination. This score quantitatively represents the difficulty level of accurately extracting information from the document. The resulting complexity score enables intelligent pre-processing triage within automated document processing pipelines, facilitating more reliable routing of documents to appropriate extraction systems or fallback strategies. This method improves the accuracy, efficiency, and robustness of downstream tasks such as text extraction, semantic parsing, and retrieval-augmented generation, especially in high-throughput or multilingual environments.

### TECHNICAL FIELD

The present invention relates generally to digital document processing, specifically to systems and methods for evaluating the layout complexity of digital documents for optimizing downstream information extraction.

### BACKGROUND OF THE INVENTION

Automated document understanding systems increasingly depend on accurate and high-quality text extraction from diverse document formats, particularly PDFs. Many PDFs contain complex layouts that reduce the performance of text extraction tools, especially when documents include multiple languages, Right-To-Left (RTL) scripts, figures, tables, or handwritten content. This negatively affects the accuracy of downstream applications such as Optical Character Recognition (OCR) systems, retrieval engines, and language models. Thus, there is a need for a system capable of preemptively evaluating the layout complexity of such documents to apply optimal processing strategies.

### SUMMARY OF THE INVENTION

The invention provides a method and system for assessing the complexity of PDF document layouts through a composite score derived from multiple document features. The complexity score facilitates classification or triage in automated pipelines. Unlike prior approaches requiring annotated training data or full layout analysis, this invention utilizes a lightweight heuristic-based complexity estimation suitable for high-throughput processing.

### BRIEF DESCRIPTION OF THE DRAWINGS

FIG. 1 illustrates a system architecture diagram depicting document input, layout parsing, feature extraction, complexity scoring, and output classification.

FIG. 2 illustrates a flowchart depicting the method for computing the complexity score.

FIG. 3 illustrates representative pages from different document types used in complexity evaluation, including plain text, mixed content, and visually complex documents.

FIG. 4 illustrates a graph demonstrating a negative correlation between complexity score and OCR extraction accuracy.

FIG. 5 illustrates binary classification performance of the complexity model, including ROC curve, Precision-Recall curve, confusion matrix, and distribution of predicted scores.

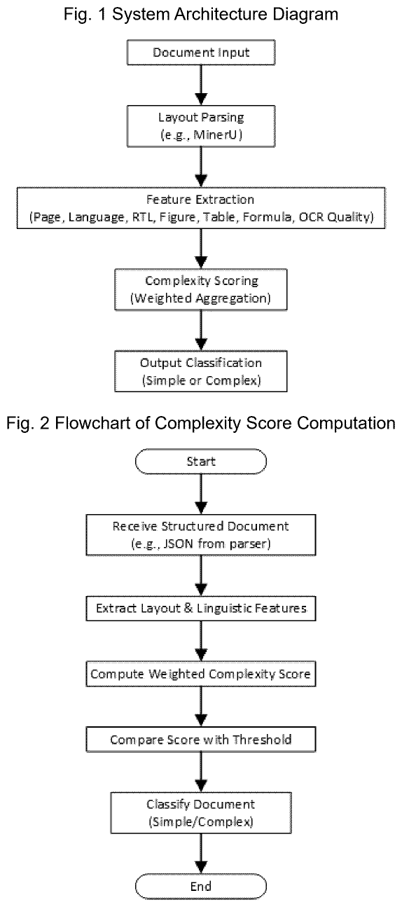

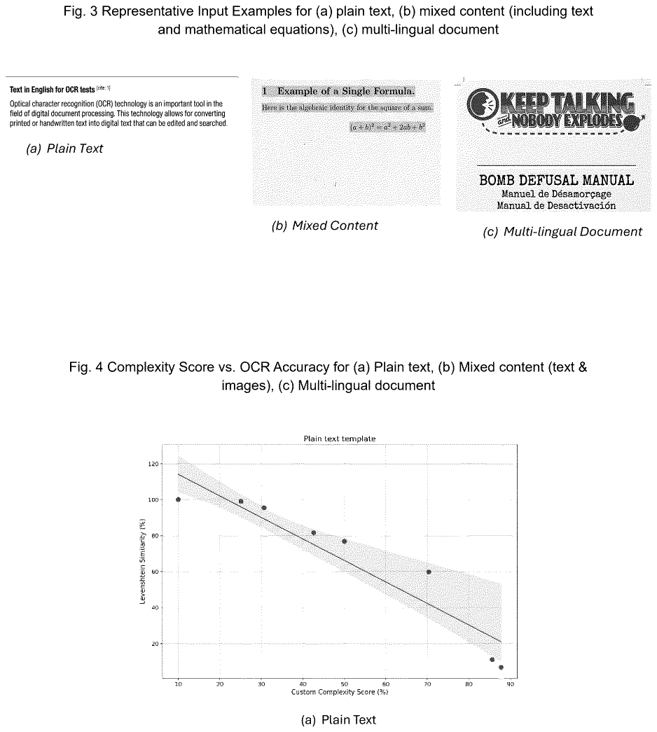

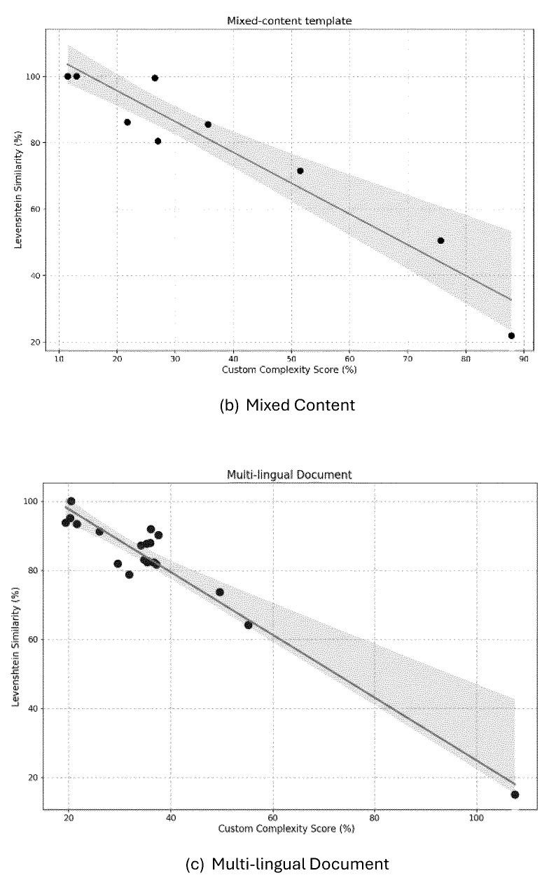

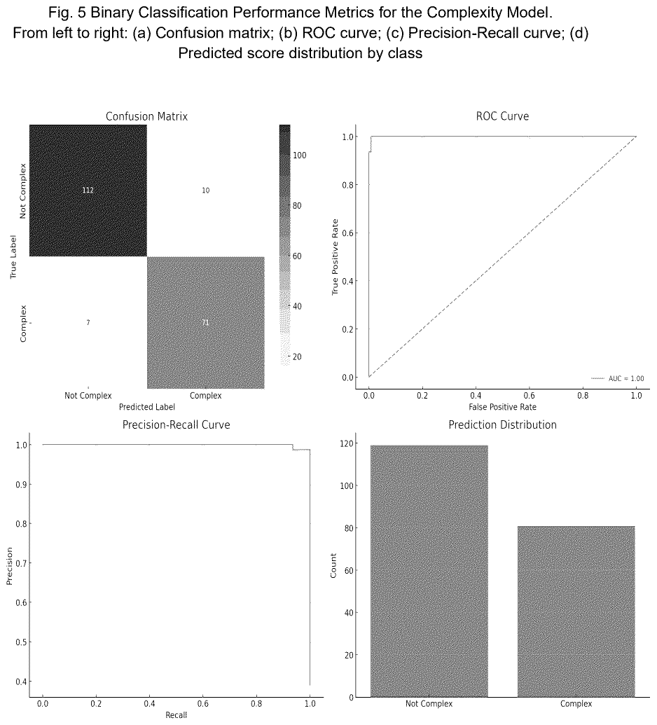

### DETAILED DESCRIPTION OF THE PREFERRED EMBODIMENTS

The system employs a modular and extensible architecture comprising five interconnected modules, each responsible for distinct processing stages from initial PDF ingestion to complexity-based document triage:
1. Input Module: Accepts digital documents in PDF format and prepares them for parsing by converting them into structured data formats compatible with downstream processing.
2. Parsing Module: Utilizes MinerU or similar advanced parsing frameworks to identify and extract specific layout elements, such as text blocks, tables, figures, and mathematical formulas. MinerU is an open-source layout-aware PDF parsing framework. It performs multi-stage document processing including layout segmentation, formula/table recognition, multilingual OCR, and reading-order recovery. MinerU outputs structured representations such as JSON and Markdown, with confidence scores and bounding boxes for individual layout elements.
3. Feature Extraction Module: Analyzes parsed data to quantify complexity indicators including, but not limited to, document length, linguistic characteristics, figure density, table frequency, presence of handwritten annotations, and OCR confidence metrics.
4. Scoring Module: Computes a comprehensive complexity score by aggregating the extracted features through empirically derived weighted coefficients. This calculation facilitates precise complexity assessment tailored to specific processing requirements.
5. Decision Module: Employs a predefined complexity threshold to classify documents into categories of varying complexity. This classification supports targeted downstream routing, enabling specialized handling of complex documents through dedicated fallback mechanisms.

The modular design of the system promotes flexibility, scalability, and ease of integration into existing document processing workflows, allowing each module to be independently updated or replaced based on evolving technological advancements or operational needs.

The disclosed system ingests structured data from a layout parser, such as JSON-formatted results from MinerU or a similar document parser. Therefore, the system extracts and quantifies the following features:
1. Page Complexity (Cpage): Computed as the normalized number of pages in the document, capped at a threshold of 100 pages.
2. Language Complexity (Clang): Calculated based on empirical extraction accuracy across languages, normalized against a baseline (e.g., English). The following list assigns relevant complexity values:
   English (en): 0.0
   French (fr): 0.2
   German (de): 0.2
   Italian (it): 0.2
   Spanish (es): 0.2
   Chinese (zh): 0.3
   Dutch (nl): 0.3
   Russian (ru): 0.4
   Hindi (hi): 0.5
   Korean (ko): 0.5
   Romanian (ro): 0.6
   Thai (th): 0.6
   Japanese (ja): 0.7
   Arabic (ar): 0.9
   Farsi (fa): 0.9
   Hebrew (he): 0.9
   Urdu (ur): 0.6
   Other: 0.3
3. RTL Script Detection (Crtl): Determined by analyzing Unicode character properties. A document is classified as RTL if at least 25% of its characters are RTL Unicode or exhibit RTL bidirectional properties, triggering an RTL complexity penalty.
4. Figure Area Impact (Cfig): Assessed based on the maximum proportional area occupied by figures multiplied by the inverse of figure detection confidence scores.
5. Handwriting Detection (Chand): Evaluated using average OCR confidence scores, flagging handwritten content if the confidence score drops below a predefined threshold (e.g., 0.7).
6. Table and Formula Density (Ctable, Cformula): Computed as ratios of table and formula elements relative to the total number of detected layout elements.
7. OCR Quality (Cocr): Measured by inverting the OCR confidence score, emphasizing documents with poor OCR quality.

The complexity score calculation is expressed as:

$${C}_{total} = {α}_{p} \cdot {C}_{page} + {α}_{l} \cdot {C}_{lang} + {α}_{r} \cdot {C}_{rtl} + {α}_{f} \cdot {C}_{fig} + {α}_{h} \cdot {C}_{hand} + {α}_{t} \cdot {C}_{table} + {α}_{ϕ} \cdot {C}_{formula} + {α}_{o} \cdot ( 1 - {Q}_{ocr} )$$

The weights (ai) are empirically optimized using Bayesian optimization to maximize classification performance on a validation dataset. The document is classified as “simple” or “complex” by comparing the complexity score to a threshold:

$$\hat{y} = \{ \begin{matrix}1 , & if {C}_{total} \geq τ \\ 0 , & otherwise\end{matrix}$$

To further validate this approach, experimental results were collected on a diverse corpus of over 200 multilingual PDF documents encompassing a wide range of structural and linguistic complexities. The system was evaluated using both regression and binary classification metrics, with Levenshtein similarity used as an independent measure of extraction accuracy. The results demonstrated a strong negative correlation (up to −0.98) between the predicted complexity scores and actual OCR performance, confirming the scoring model's reliability.

The classifier was further benchmarked in a high-stakes document triage scenario, distinguishing between “simple” and “complex” documents. Using a threshold value of 0.52, the system achieved an Area-Under-the-Curve (AUC) of 0.97, with a precision-recall tradeoff suitable for practical deployment. The proposed framework is especially valuable in downstream tasks such as Retrieval-Augmented Generation (RAG), where layout-induced noise can significantly degrade Large Language Model (LLM) performance.

This scoring system can be integrated seamlessly into production pipelines, allowing documents to be pre-screened for structural risk. Fallback strategies such as alternate parsing engines, manual review, or delayed processing can be applied selectively based on complexity classification, improving both throughput and result quality.

1. A method comprising: receiving a structured representation of a digital document; extracting a plurality of layout and linguistic features; computing a weighted complexity score based on said features; classifying the document as complex or simple based on a predetermined threshold.

2. The method of claim 1, wherein the features include page count, language complexity, RTL ratio, figure density, table count, formula count, handwriting presence, and OCR confidence.

3. The method of claim 1, wherein the complexity score is computed as a weighted sum of the extracted features.

4. The method of claim 1, wherein language complexity is computed using a predefined mapping correlating languages to extraction difficulty.

5. The method of claim 1, wherein RTL detection utilizes Unicode bidirectional character properties.

6. The method of claim 1, wherein classification results route documents to specialized extraction systems based on complexity.

7. The method of claim 1, wherein the document parser comprises MinerU or an equivalent parser.

8. A system comprising: a parsing module configured to extract layout and text features; a language and script analysis module; a feature scoring module; a complexity aggregation module; an output module configured to classify or route documents.

9. The system of claim 8, further comprising a threshold-based document triage mechanism.
